(19) United States
(12) Patent Application Publication
(10) Pub. No.: US 2012/0249341 A1
(43) Pub. Date: Oct. 4, 2012

(54) Communication of emergency messages with road markers

(75) Inventors: Craig M. Brown, Harbord (AU); Craig W. Northway, Aspley (AU); Jessica M. Purser, Ashfield (AU); Gregory G. Rose, San Diego, CA (US)

(73) Assignee: QUALCOMM Incorporated, San Diego, CA (US)

(21) Appl. No.: 13/076,227

(22) Filed: Mar. 30, 2011

(51) Int. Cl. G08G 1/00

(52) U.S. Cl. 340/902

(57) ABSTRACT

Disclosed is an apparatus, system, and method to communicate emergency messages utilizing road markers. The road marker may include: a light emitter to emit different light colors; a transmitter; and a receiver to receive an emergency message from an emergency vehicle, a road marker gateway, or another road marker. Further, the road marker may include a processor to: to command the light emitter to emit a light color based upon the emergency message received by the receiver; and command the transmitter to transmit the received emergency message to at least one other road marker.

### BACKGROUND

1. Field

The present invention relates generally to an apparatus, system, and method to communicate emergency messages utilizing road markers.

2. Relevant Background

Today, worldwide highway and road traffic flow control is typically done independently and visually on an intersection-by-intersection basis using age-old magnetometer vehicle detection coupled with timed signal lights. Government agencies are aware of the increased safety and resulting cost saving potentials associated with making highways more intelligent. More informed and aware drivers will result in fewer traffic accidents which in turn results in less emergency response calls, less insurance claims, and great cost savings.

Thousands of people die or are seriously injured from traffic accidents when they could have been saved or had better outcomes if emergency services had arrived just a few minutes earlier. In addition, multiple vehicle accidents often occur because of the lack of warning of impending danger ahead from accidents or stopped traffic.

One approach that has been utilized is the use of portable and fixed programmable signs that are placed along the roadside. Although, a portable sign can sometimes be quickly dispatched to an accident scene, doing so nevertheless takes a significant amount of time. Fixed signs, on the other hand, are usable only on the location where they are erected. In addition, both portable and fixed signs must be programmed at the time needed with a message to display. Further, pavement markers have been proposed that can indicate to drivers to merge in case of traffic. However, none of these systems communicate emergency messages utilizing road markers to drivers.

### SUMMARY

Embodiments of the invention may relate to an apparatus, system, and method to communicate emergency messages utilizing road markers. In one embodiment, a road marker may include: a light emitter to emit different light colors; a transmitter; and a receiver to receive an emergency message from an emergency vehicle, a road marker gateway, or another road marker. Further, the road marker may include a processor to: to command the light emitter to emit a light color based upon the emergency message received by the receiver; and command the transmitter to transmit the received emergency message to at least one other road marker.

### BRIEF DESCRIPTION OF THE DRAWINGS

FIG. 1 is a diagram illustrating a system to communicate emergency messages utilizing road markers for a highway having a plurality of lanes in which a plurality of cars, trucks, and other vehicles drive on.

FIG. 2 is a block diagram of a WIRM.

FIG. 3 is a block diagram illustrating the components of a WIRM gateway and a traffic management station.

FIG. 4 is a flow diagram that illustrates a process to implement the lighting of WIRMS.

FIG. 5 is a block diagram showing the traffic emergency system.

### DETAILED DESCRIPTION

The word “exemplary” is used herein to mean “serving as an example, instance, or illustration.” Any embodiment described herein as “exemplary” or “example” is not necessarily to be construed as preferred or advantageous over other embodiments.

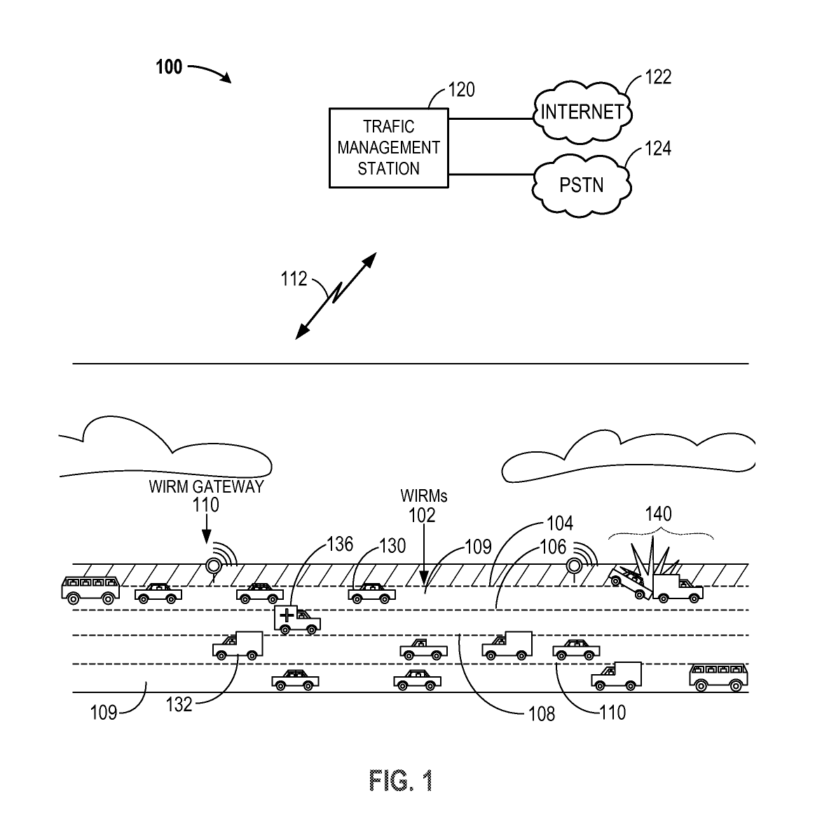

With reference to FIG. 1, FIG. 1 is a system diagram in which embodiments of the invention may be practiced. In particular, in one embodiment, a wireless emergency system 100 having a plurality of wireless intelligent road markers (WIRMS) 102 that communicate emergency messages with one another in combination with a plurality of WIRM gateways 110 and a traffic management station 120 is illustrated. As will be described in more detail, the WIRMS 102 may be used to emit light of different colors, flashes, etc., to warn drivers of emergency situations such as a vehicle accident 140, bad weather, road/lane problems, traffic congestion, closed lane, etc. Further, by the WIRMS 102 communicating with each other, the WIRMS 102 can transmit these emergency messages down the road to oncoming traffic.

As can be seen in FIG. 1, a highway is illustrated having a plurality of lanes 109 in which a plurality of cars 130, trucks 132, buses, etc., and other vehicles are driving. As can be further seen on FIG. 1, each of the lanes 109 may have a corresponding group of WIRMS 104, 106, 108, and 110 that may be utilized to emit light and flashes to warn drivers about vehicle accidents 140, bad weather, road/lane problems, traffic congestion, closed lane, etc.

The WIRMS 102 may communicate with one another, along with a plurality of WIRM gateways 110, and through link 112 with a traffic management station 120. Traffic management station 120 may further be connected to the Internet 122, the public switch telephone network (PSTN) 124, along with other data sources.

As one particular example, a WIRM 106 may receive an instruction from an emergency vehicle 136 that a traffic accident 140 has occurred such that WIRMS 104 and 106 associated with that lane 109 are commanded to emit a red color indicating to drivers 130 to merge into another lane and that the lane is closed such that vehicles will avoid the upcoming car accident 140 and will free the lane for the emergency vehicle 136. This emergency message may be transmitted from the emergency vehicle 136 to the nearest WIRM 104 and thereafter on to the other WIRMS 104 and 106, on WIRM by WIRM basis, as well as to a WIRM gateway 110. From the WIRM gateway 100 this emergency message may be transmitted via a link 112 to the traffic management station 120 to indicate to the traffic management station 120 that a traffic accident 140 has occurred, the specific location of the traffic accident, as well as what portions of the lanes have been closed to allow for the emergency vehicle 136 to attend to the traffic accident 140.

Thus, in one embodiment, a WIRM 102 receives an emergency message from an emergency vehicle 136 and transmits this message to the surrounding WIRMS 104 and 106 to warn drivers of the emergency and these WIRMS may indicate the emergency by turning to a red color or flashing a red color. It should be appreciated that one or both sides of the lane WIRMS 104 and/or 106 may be turned red or flash red to indicate to drivers to exit the lane to avoid further traffic collisions and to aid the approach of emergency vehicle 136. Thus, an accident 140, in the distance may be indicated to drivers by WIRMS 104 and 106 sending a message to oncoming traffic. Accordingly, as one example, WIRMS 104 and 106 may communicate with each other and further this emergency data may be transmitted to a WIRM gateway 110 and further via link 112 to the traffic management station 120.

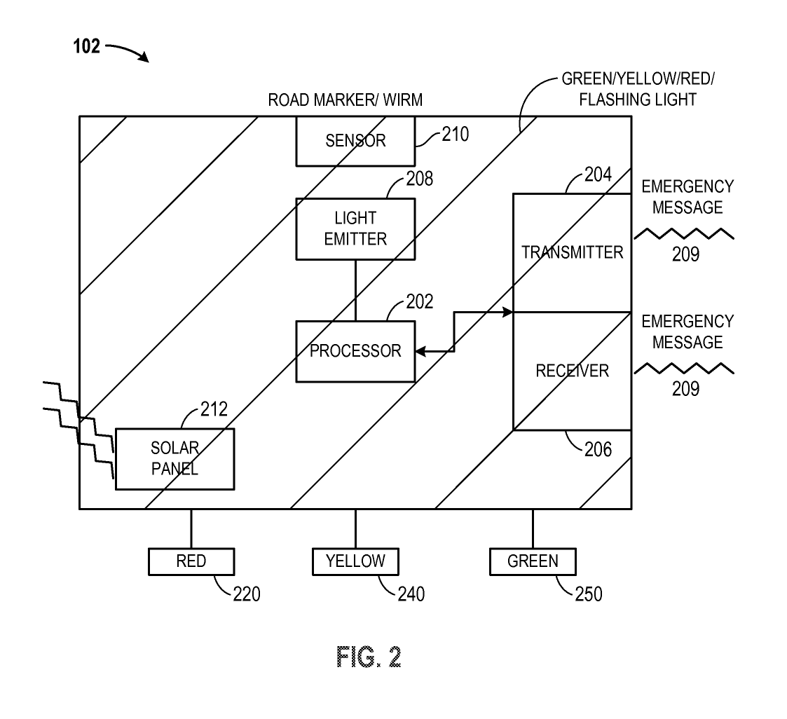

With additional reference to FIG. 2, a block diagram of a WIRM 102, according to one embodiment, is illustrated. A WIRM 102 that is used to communicate emergency messages with other WIRMS 102 (as well as to a WIRM gateway 110) may comprise: a light emitter 208 (e.g., an LED) to emit different light colors (e.g. red 220, yellow 240, green 250); a transmitter 204 to transmit an emergency message 209; a receiver 206 to receive an emergency message 209 from an emergency vehicle 136, a road marker gateway 110, or another WIRM 102; and a processor 202. The processor 202 may be used to: command the light emitter 208 to emit a light color based upon the emergency message 209 received by the receiver 206; and command the transmitter 204 to transmit the received emergency message 209 to nearby WIRMS (e.g., all WIRMS within range, lane specific WIRMS, and/or specifically identified WIRMS). The WIRMS communicated to may be designated based upon the type of emergency and locations, such as, vehicle accidents, bad weather conditions, road/lane problems, traffic congestion, closed lane, etc.

Further, the wireless emergency system 100 includes many different types of ways that emergency messages can be transmitted to WIRMS 102. For example, an emergency message 209 may be transmitted from an emergency vehicle 136 to a WIRM 102, a WIRM gateway 110, and to the traffic management station 120. As an example, the emergency vehicle 136 may have been notified about the accident (e.g., from the fire or police department based upon a x911 call) but was uncertain as to the location of the accident. As soon as the emergency vehicle 136 locates the accident 140, it sends an emergency message to the nearest WIRM 102. That WIRM 102 transmits the emergency message to its next adjacent WIRM and each WIRM passes on the message to the other WIRMS, such as WIRMS 104 and WIRMS 106, such that they turn to or flash red to indicate to drivers that the lane is closed and that an emergency vehicle is approaching. This emergency message 209 may also be transmitted from the emergency vehicle 136 or by a WIRM 102 to the nearest WIRM gateway 110 and by the WIRM gateway 110 through wireless link 112 to the traffic management station 120 in order to identify the accident, the accident location, as well as the type of accident.

As another example, a random vehicle 130 may see an accident 140 and either directly call the traffic management station 120 or the traffic management station may be notified by a vehicle's call to x911 and the traffic management station 120 via link 112 may transmit the accident information to a WIRM gateway 110 and the WIRM gateway 110 may then transmit the emergency message to a WIRM 102. The WIRM 102 may then in conjunction with all of the other appropriate WIRMS (e.g., WIRMS 104 and 106) communicate emergency messages 209 to one another to display or flash a red light for a certain pre-defined area to indicate to drivers that they clear the lane because of a traffic accident 140 and that an emergency vehicle 136 is approaching. Thus, an emergency message may be transmitted from the traffic management station 120 via link 112 to a WIRM gateway 110 and to the WIRMS 102.

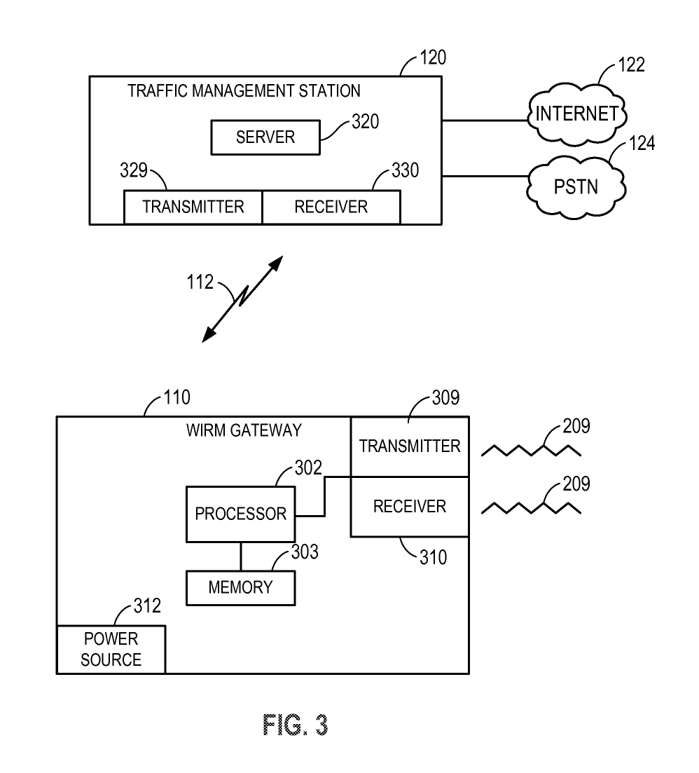

Turning briefly to FIG. 3, FIG. 3 is a block diagram illustrating the components of the WIRM gateway 110 and the traffic management station 120 that may be utilized by the wireless emergency system 100, according to one embodiment. In one embodiment, WIRM gateway 110 may include a processor 302, memory 303, transmitter 309, receiver 310, and power source 312. Transmitter 309 may transmit emergency messages 209 via transmitter 309 to WIRMS 102, emergency vehicles 136, and to traffic management station 120 via link 112; and may receive emergency messages 209 via receiver 310 from WIRMS 102, emergency vehicles 136, and from the traffic management station 120 via link 112.

Further, the traffic management station 120 may include a server 320, a transmitter 329, and a receiver 330. Traffic management station 120 may be connected to the Internet 122 and the public switch telephone network (PSTN) 124. The traffic management station 120 may receive emergency data from callers, vehicles, emergency vehicles, the Internet, or a wide variety of different sources, and may transmit these emergency messages via link 112 to a WIRM gateway 110 such that WIRM gateway 110 can pass on this emergency message data to the WIRMS 102 regarding such things as vehicle accidents, bad weather, road/lane problems, traffic congestion, closed lane, etc. Additionally, as previously described, traffic management station via receiver 330 may receive via link 112 emergency messages from WIRM gateways 110.

Particular examples will now be described. As one example, the emergency message 209 may be a “traffic collision” or “closed lane” message. In this instance, the processor 202 of a WIRM 102 commands the light emitter to emit a red color 220 to communicate the “closed lane” message to drivers and the processor 202 commands the transmitter 204 to transmit the received “closed lane” emergency message 209 to the other WIRMS 102.

A particular previously-described example of this may be a lane 109 in which a vehicle collision 140 occurred and some of the WIRMS 104 and 106 for a particular pre-defined distance are commanded to emit the red light such that vehicles 130 are told switch lanes to avoid the vehicle collision 140 and to allow an emergency vehicle 136 to obtain quick access to the vehicle collision 140. In this instance the emergency message may also be referred to as a “traffic collision” message. Of course other “closed lane” messages may be related to a rock-slide associated with a lane, another type of accident that has occurred in a lane, a dropped item in a lane, etc.

As another example, the emergency message 209 may be a “bad weather” message. In this instance, the processor 202 of a WIRM 102 commands the light emitter to emit a yellow color 240 to communicate the “bad weather” message to drivers and the processor 202 commands the transmitter 204 to transmit the received “bad weather” emergency message 209 to the other WIRMS 102. Thus, bad weather conditions such as snow, ice, hail, rain, etc., can be communicated with yellow lights to alert drivers to slow down.

As yet another example, the emergency message 209 may be a “traffic congested” message. In this instance, the processor 202 of a WIRM 102 commands the light emitter to emit a yellow color 240 to communicate the “traffic congested” message to drivers and the processor 202 commands the transmitter 204 to transmit the received “traffic congested” emergency message 209 to the other WIRMS 102. Thus, traffic congestion conditions can be communicated with yellow lights to alert drivers to slow down.

Therefore, as can be seen in FIG. 1, each of the lanes 109 may have a corresponding group of WIRMS 104, 106, 108, and 110 that may be utilized to emit light and flashes (of red and yellow) to warn drivers about vehicle accidents 140, bad weather, road/lane problems, traffic congestion, closed lane, etc. Of course, green lights can indicate to drivers that there are no problems currently associated with the lane 109.

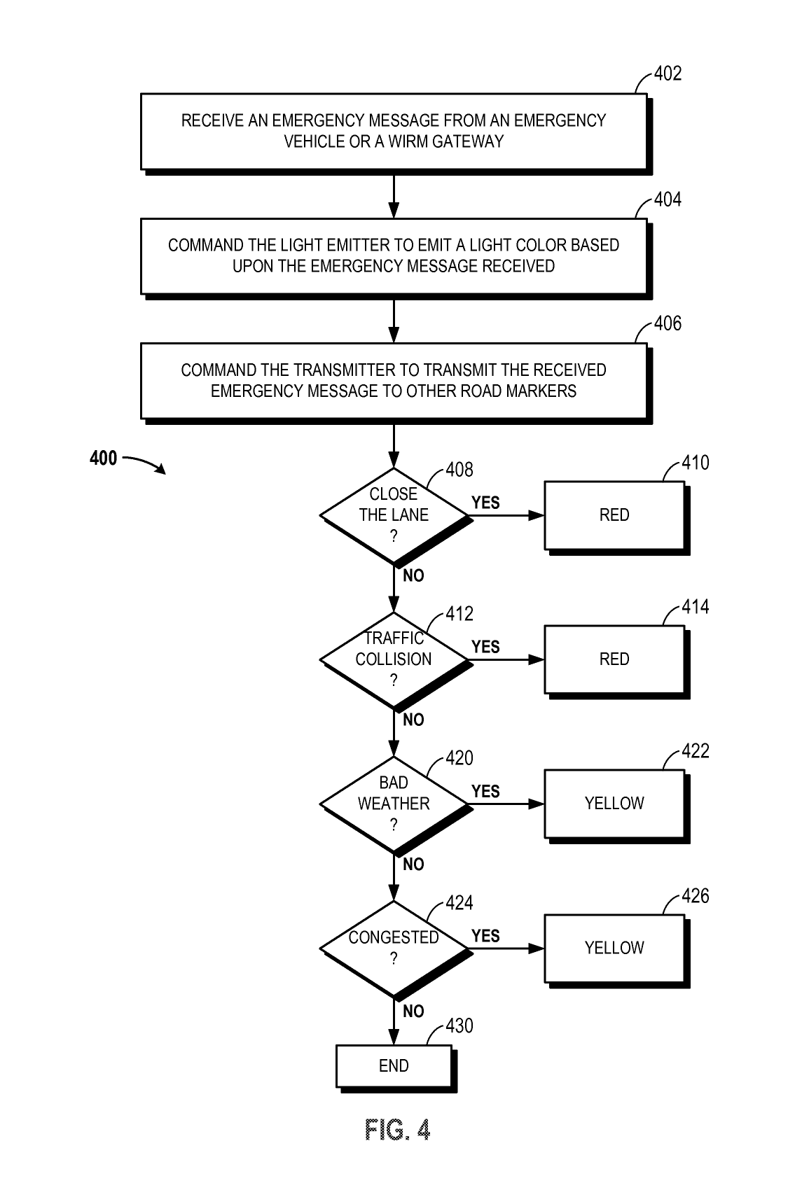

With brief reference to FIG. 4, a flow diagram that illustrates a process 400 to implement the lighting of WIRMS, as previously described, according to one embodiment, will be described. At block 402, an emergency message from an emergency vehicle or a WIRM gateway is received at a WIRM. Next, at block 404, the light emitter of a WIRM is commanded to emit a light color (e.g., red, yellow, flashing, etc.) based upon the emergency message received. Further, a transmitter of the WIRM is commanded to transmit the received emergency message to other nearby WIRMS (block 406).

In particular, if the emergency message is a “close the lane” message (decision block 408) then the light emitter emits red (block 410). If not, if the emergency message is a “traffic collision” message (decision block 412) then the light emitter also emits red (block 414). If not, and the emergency message is determined to be a “bad weather” message (decision block 420), then the light emitter emits yellow (block 422). If not, it is next determined whether the emergency message is a “traffic congested” message (decision block 424) and if so, the light emitter emits yellow also (block 426). If not, process 400 ends (block 430). Of course, green lights can indicate to drivers that there are no problems currently associated with the lane 109.

Again, with particular reference to FIG. 2, a WIRM 102 may include a solar panel 212 to provide power to the WIRM 102. Also, WIRM 102 may include a sensor 210, such as, an optical sensor or a motion vibration sensor, to monitor vehicle traffic such that the processor 202 may determine whether vehicle traffic is congested, and if so, command the light emitter 208 to emit a yellow 240 color, or, if not congested, command the light emitter 208 to emit a green 250 color. Further, processor 202 can command the transmitter 204 to transmit the monitored vehicle traffic congestion message 209 to other WIRMS 102 (such that they can likewise emit yellow to warn drivers of traffic congestion), as well as, through a WIRM gateway 110 to the traffic management station 120. In this way, the traffic management station 120 can pass the traffic congestion data onto Internet websites and to vehicles themselves such that the traffic congestion is automatically and widely distributed.

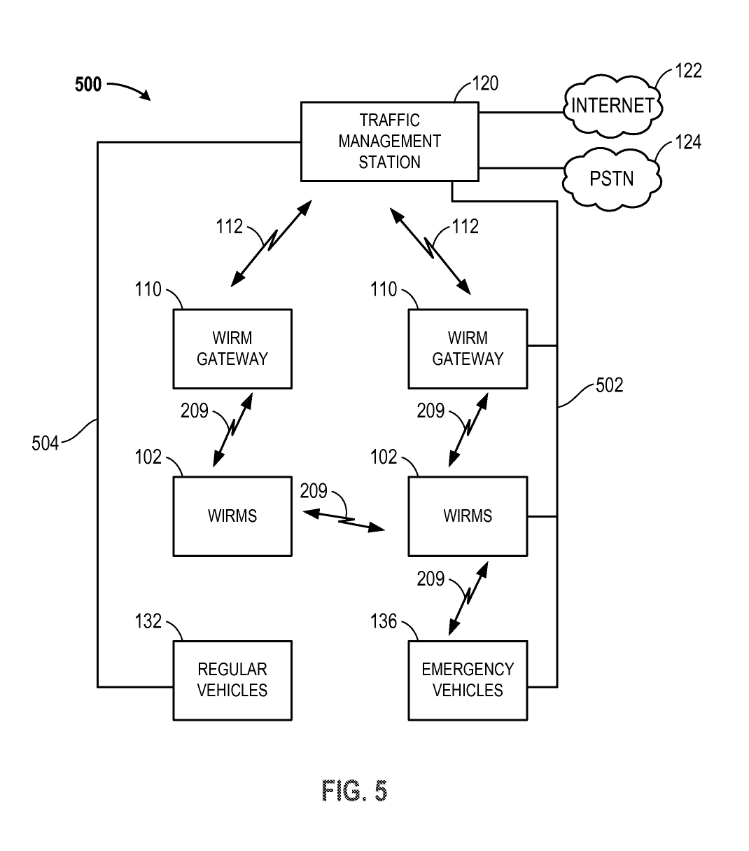

With reference to FIG. 5, a block diagram showing the complete traffic emergency system 500, according to one embodiment, is shown. As can be seen in FIG. 5 in addition to FIG. 1 and the other figures, emergency vehicles 136 can correspond via wireless link 209 to WIRMS 102 and through wireless link 502 to WIRM gateways 110 and the traffic management station 120. Further, regular vehicles 132 may communicate via a wireless link 504 to the traffic management station 120. Additionally, other users, vehicles, etc., can communicate with the traffic management station via the Internet 120, the PSTN 124, or by other means. For example, a x911 call to a police or fire station (or the information from a call) may be passed on to the traffic management station 120. It should be appreciated that vehicles that communicate information not only include on-the-road vehicles but may also include off-the-road vehicles such as helicopters, planes, etc.

Additionally, as previously described, WIRMS 102 may communicate emergency messages 209 with each other and to the WIRM gateways 110 and the WIRM gateways 110 may further communicate with the traffic management station 120. Conversely, the traffic management station 120 may communicate emergency messages via link 112 to the WIRM gateways 110 and WIRMS 102.

Thus, as one example, to implement the WIRM system 500, three main components may be utilized: the WIRMS 102, WIRM gateways 110, and the traffic management station 120. As an example, the WIRMS 102 may communicate with each other utilizing low-power wireless network technology via wireless emergency messages 209. The WIRMS 102 may be self-powering (using solar energy), and this energy may be sufficient to power the LED lights highlighting the location of the WIRMS 102 to drivers. As previously discussed, the WIRMS 102 may be remotely instructed to provide a variety of lighting colors, flashes, and/or patterns. Also, as previously described, a WIRM 102 may have additional capabilities enabling the WIRM 102 to provide traffic monitoring information to the traffic management station 120.

Further, the WIRM gateways 110 may be installed beside the highway. The WIRM gateways 110 may communicate with the WIRMS 102 and may communicate with the traffic management station 120 via WWAN (or other similar technologies). In essence, these devices facilitate communication between the WIRMS 102 and the traffic management station 120. The WIRM gateways 110 may require more power than a small solar-cell provides such that WIRM gateways, in one embodiment, may utilize a large solar panel such as those used by road-side emergency phones.

The traffic management station 120 may include an appropriate system that includes sufficient hardware and software (e.g. servers, computers, phone lines, etc.) to provide an operations and service center. The traffic management station 120 in conjunction with the WIRM gateways 110 may provide instructions to the WIRMS 102 and also receive data observed by the WIRMS 102. The traffic management station 120 also may provide services to external systems. Examples of such services include providing traffic recommendations to vehicle GPS navigation units or supporting a traffic-monitoring web-site via the Internet 122.

The WIRMS 102 provide visual clues to drivers to enhance safety. In order to accomplish this, as previously described, the WIRMS 102 use lights illuminating in a variety of colors, flashes, and/or patterns. Examples of this may include: green—normal; yellow and/or flashing—slow down or prepare to stop/merge (traffic congestion, accident ahead, bad weather); red—lane closed (e.g. emergency vehicle approaching, bad accident, vehicle collision, road problems). In one example, WIRMS 102 may be generally placed 20 meters apart and with an appropriate radio range, such as, 75 meters. WIRMS 102 may communicate with a number of surrounding WIRMS ensuring that the failure of multiple adjacent WIRMS would not affect the entire system.

Thus, for traffic conditions affected by accidents, bad weather, road problems (e.g., rock slides), and traffic congestion, the emergency system 500 utilizing WIRMS 102 may warn oncoming drivers to slow down or change lanes. Further, emergency vehicles can close lanes to gain access to accident sites. Additionally, by controlling the WIRM system centrally (e.g. utilizing traffic management station 120), it may be used for deterring traffic and/or highlighting bad weather conditions. During peak traffic times, special/stadium events, a WIRM system may be used to reconfigure lane direction and divert traffic. Integration with traffic signals could intelligently aid flow. Such a system would be more configurable than current manual approaches. Safety zones including train and pedestrian, school zones, and bike paths may be illuminated when crossing traffic is present. By having the road surface look different when there is a pedestrian/bike/train present, the intersecting traffic will be more noticeable.

Additionally, as previously described, when the WIRMS 102 utilize an optical or motion vibration sensor to monitor vehicle traffic, the WIRM system 500 may be used more accurately than existing traffic analysis systems and may be used for GOOGLE MAPS and/or an Internet-based government style traffic congestion reporting system. The accurate flow information may be fed into car systems as well to dynamically update the fastest route to a destination. In another embodiment, drivers may be able get automated road conditions (weather, traffic flow), accident alerts, alternate routes, emergency vehicles nearby, pedestrians and crosswalks, bikes and bike lanes, etc. There are further features that could be implemented utilizing WIRMS 102. For example, WIRMS 102 could have capabilities (sensors) for feeding traffic, road, and weather conditions back to the traffic management station 120 via the WIRM gateway 110 or a direct link 502. Also, in another embodiment, WIRMS 102 could transmit messages to vehicles and systems in the vehicles to act on such as signals that automatically brake the vehicle due to an upcoming close accident or automatically display to the user a warning that a traffic accident, bad weather, a rock slide etc., is very close (e.g., in one-half mile a bad traffic accident occurred).

The WIRM based system 500 may also be used to monitor traffic congestion, oncoming traffic speed, and warn traffic to break in slow or spotted traffic conditions such as accidents, bad weather, and congestion. Emergency vehicles 136 could be used to close lanes to gain access. By controlling the WIRM system centrally such as via a traffic management station 120, the WIRM system could be used for deterring traffic and highlighting bad weather conditions. During peak traffic times, special/stadium events, a WIRM system could be used to reconfigure lane direction and divert traffic. Integration with traffic signals could intelligently aid flow. Such a system may be more configurable than current manual approaches. Further, safety zones including train and pedestrian, school zones and bike paths may likewise be illuminated utilizing WIRMS 102 when crossing traffic is present. By having the road surface look different when there is a pedestrian/bike/train present, the intersecting traffic may be more noticeable. Further, the WIRM system could be used to monitor erratic driving, speeding and also could be combined with cameras to identify potential perpetrators. Such systems could also be used to track stolen vehicles and missing people. For example, WIRMS 102 could include cameras and these cameras could be utilized to identify cars by photographing license plates and employing optical character recognition algorithms.

Thus, the WIRM based system 500 may implement huge improvements in maximizing freeway safety and control. For example, the WIRM based system 500 utilizing the WIRMS 102 coloring may implement traffic control flow in terms of regular lane traffic and transit lane traffic during peak times. As an example, a 4×4 lane highway could be reconfigured for 1 incoming, and 7 outgoing lanes. Additionally, the WIRMS 102 can monitor traffic in lanes, in case of emergencies, e.g., a vehicle accidently gets in the wrong lane. Further, as previously described, the WIRM based system 500 can configure lanes for stadiums and special events and can be integrated with traffic lights to allow for more intelligent traffic flow. The WIRM based system 500 can establish safety zones such the WIRMs 102 can illuminate surrounding lanes and roads when there is a situation that warrants attention, such as, when there is a pedestrian/bike/train present. For example, bike lanes could illuminate behind a cyclist to inform approaching traffic. Also, school zones could be highlighted during school hours. Additionally, the WIRMS 102, much like accident warning, could determine car speed and be integrated with traffic lights/crossings to indicate braking required, especially where intersection is around a blind corner.

Further, the WIRM based system 500 utilizing WIRMS 102 may implement traffic monitoring and diversion, such as: re-routing traffic in an emergency situation by closing lanes and changing lane direction and highlighting detours for emergency and roadwork including weather issues such as flooded or icy roads. WIRM based system 500 may be useful in accident analysis, such as, the WIRMS 102 monitoring speed and braking activities to help determine accident fault. Additionally, WIRM based system 500 may provide very accurate traffic monitoring that can be performed with sensors in the WIRMS 102 rather than the current very low-resolution system of sensors on freeway exists. This information can then be transmitted back to the traffic management station 120 for implementation with systems such as GOOGLE MAPS TRAFFIC and Internet-based government systems. Additionally, displays could be integrated into side-of-the-road displays to indicate traffic conditions including items such as “Time to LAX: 22 minutes”. These would be far more accurate than existing systems. In-car navigation systems could utilize the live traffic monitoring information from the WIRMS 102 to map the fastest route to a destination. In-car systems could display time-to-destination information retrieved from the WIRM based system 500 via a web interface, or directly from the WIRMS 102.

Moreover, the WIRM based system 500 utilizing WIRMS 102 may implement vehicle monitoring by cameras in the WIRMS 102 and WIRM gateway 110 to monitor for speeding and erratic drivers; drunk drivers; drivers veering within lanes. Additionally, the WIRM based system 500 may be integrated with stolen vehicle tracking systems and can be used in child abduction and missing person tracking. Vehicles may also interact with the WIRM based system. For example, autonomous cruise control systems could interact with the WIRMS to determine upcoming conditions and act accordingly. As an example, a vehicle could be commanded to brake to a complete halt in ½ mile due to a rock slide. These types of information could be displayed in a vehicle's heads-up-display. This could be particularly useful in low visibility situations such as fog, snow and heavy rain.

The WIRM system may also allow for more advanced functionality including autonomous cruise control systems that interact with road surface and automatically control the car. Another advanced system would be in-car heads-up display on the road surface. This could be useful in low visibility situations.

Additionally, an embodiment is presented that provides a procedure to determine the location coordinates for WIRMS 102 and WIRM gateways 110. Hereinafter the term “node” refers to WIRM. In particular, the hereinafter described procedure relates to determining location coordinates for the self-organizing WIRM system using short-range wireless transfer.

This procedure explains how to calculate absolute location coordinates for nodes in a mesh network using short-range wireless transfer. Here, the location coordinates are tuples (X, Y, Z) representing GPS positions (latitude, longitude, altitude).

A node represents an intelligent WIRM, a device that uses short-range wireless transfer to communicate with other nodes. A gateway node is more powerful and can communicate over larger distances. It also contains a wired-link to a network and knows its own GPS position.

A local node of nᵢ is a node that is within range of wireless communication. A node nᵢ uses short-range wireless transfer to discover the distance to each local node. The information gathered by each node is relayed back to a gateway node for processing.

The gateway node builds a multivariate quadratic system of equations using the information received. This system of equations can generally be solved using standard algorithms to find a unique solution, provided there are a sufficient number of equations in comparison to the number of variables. Solving these types of systems becomes less complex if the system is over-defined (number of equations>number of variables).

Two Dimensions

Assumption 1: Each node is local to at least 2 other nodes.

Assumption 2: Each gateway-node is local to at least 2 other nodes.

Let (Xᵢ, Yᵢ) denote the absolute coordinates of node nᵢ. The distance dᵢⱼ between two nodes nᵢ and nⱼ can be expressed as:

(Xᵢ−Xⱼ)²+(Yᵢ−Yⱼ)²=dᵢⱼ².

For each node, there are 2 unknown variables (Xᵢ, Yᵢ). For a system of n nodes, this gives 2n variables. For each node-node distance discovered, there is 1 equation in 4 variables. For each node-gateway distance discovered, there is 1 equation in 2 variables (since the gateway coordinates are known).

If assumption 1 holds, the number of node-node equations is at least 2n−3 in 2n variables. Each gateway-node introduces at least 2 more equations with no additional variables. For a system including 4 gateway-nodes, there are at least 2n+5 equations in 2n variables.

Three Dimensions

Assumption 1: Each node is local to at least 3 other nodes.

Assumption 2: Each gateway-node is local to at least 3 other nodes.

Let (Xᵢ, Yᵢ, Zᵢ) denote the absolute coordinates of node nᵢ. The distance dᵢⱼ between two nodes nᵢ and nⱼ can be expressed as:

(Xᵢ−Xⱼ)²+(Yᵢ−Yⱼ)²+(Zᵢ−Zⱼ)=dᵢⱼ².

For each node, there are 3 unknown variables (Xᵢ, Yᵢ, Zᵢ). For a system of n nodes, this gives 3n variables. For each node-node distance discovered, there is 1 equation in 6 variables. For each node-gateway distance discovered, there is 1 equation in 3 variables (since the gateway coordinates are known).

If assumption 1 holds, the number of node-node equations is at least 3n−3 in 3n variables. Each gateway-node introduces at least 3 more equations with no additional variables. For a system including 4 gateway-nodes, there are at least 3n+9 equations in 3n variables.

It should be appreciated that embodiments of the invention previously described may be implemented in conjunction with the execution of instructions by processors (e.g., processors of the WIRMs 102, WIRM gateways 110, and the traffic management station 120) and/or other circuitry and/or other devices. Particularly, this circuitry, including but not limited to processors, may operate under the control of a program, routine, or the execution of instructions to execute methods or processes in accordance with embodiments of the invention. For example, such a program may be implemented in firmware or software (e.g. stored in memory and/or other locations) and may be implemented by processors and/or other circuitry. Further, it should be appreciated that the terms processor, microprocessor, circuitry, controller, etc., refer to any type of logic or circuitry capable of executing logic, commands, instructions, software, firmware, functionality, etc.

Further, the WIRMs 102, WIRM gateways 110, and the traffic management station 120 may communicate via one or more wireless communication links that are based on or otherwise support any suitable wireless communication technology. For example, in some aspects a wireless device may associate with a network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless devices may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), an entertainment device (e.g., a music or video device), a headset (e.g., headphones, an earpiece, etc.), a microphone, a medical device (e.g., a biometric sensor, a heart rate monitor, a pedometer, an EKG device, etc.), a user I/O device (e.g., a watch, a remote control, a light switch, a keyboard, a mouse, etc.), a tire pressure monitor, a computer, a point-of-sale device, an entertainment device, a hearing aid, a set-top box, or any other suitable device.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects a wireless device may comprise an access device (e.g., a Wi-Fi access point) for a communication system. Such an access device (also referred to as a base station) may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A road marker to communicate emergency messages with other road markers comprising:
a light emitter to emit different light colors;
a transmitter;
a receiver to receive an emergency message from an emergency vehicle, a road marker gateway, or another road marker; and
a processor to:
command the light emitter to emit a light color based upon the emergency message received by the receiver; and
command the transmitter to transmit the received emergency message to at least one other road marker.

2. The road marker of claim 1, wherein, the emergency message is transmitted from an emergency vehicle to the road marker, a road marker gateway, or a traffic management station.

3. The road marker of claim 1, wherein, the emergency message is transmitted from a vehicle to a traffic management station, to a road marker gateway, and to the road marker.

4. The road marker of claim 1, wherein, the emergency message is transmitted from a traffic management station to a road marker gateway and to the road marker.

5. The road marker of claim 1, wherein, if the emergency message is a “close the lane” message, the processor commands the light emitter to emit a red color to communicate the “close the lane” message to drivers and the processor commands the transmitter to transmit the received “close the lane” message to other road markers.

6. The road marker of claim 1, wherein, if the emergency message is a “traffic collision” message, the processor commands the light emitter to emit a red color to communicate the “traffic collision” message to drivers and the processor commands the transmitter to transmit the received “traffic collision” message to other road markers.

7. The road marker of claim 1, wherein, if the received message is a “bad weather condition” message, the processor commands the light emitter to emit a yellow color to communicate the “bad weather condition” message to drivers and the processor commands the transmitter to transmit the received “bad weather condition” message to other road markers.

8. The road marker of claim 1, wherein, the light colors emitted by the light emitter include at least one of green, yellow, or red.

9. The road marker of claim 8, wherein, the light colors are flashing.

10. The road marker of claim 1, further comprising at least one of an optical sensor or a motion vibration sensor to monitor vehicle traffic, the processor to determine whether vehicle traffic is congested, and to command the light emitter to emit a yellow color, or, if not congested, to command the light emitter to emit a green color, and the processor to command the transmitter to transmit the monitored vehicle traffic to other road markers, to a road marker gateway and to a traffic management station.

11. A method to communicate emergency messages between road markers comprising:
receiving an emergency message at a road marker from an emergency vehicle, a road marker gateway, or another road marker;
commanding a light emitter to emit a light color based upon the emergency message received; and
transmitting the received emergency message to at least one other road marker.

12. The method of claim 11, wherein, the emergency message is transmitted from an emergency vehicle to the road marker, a road marker gateway, or a traffic management station.

13. The method of claim 11, wherein, the emergency message is transmitted from a vehicle to a traffic management station, to a road marker gateway, and to the road marker.

14. The method of claim 11, wherein, the emergency message is transmitted from a traffic management station to a road marker gateway and to the road marker.

15. The method of claim 11, wherein, if the emergency message is a “close the lane” message, further comprising the light emitter emitting a red color to communicate the “close the lane” message to drivers and transmitting the received “close the lane” message to other road markers.

16. The method of claim 11, wherein, if the emergency message is a “traffic collision” message, further comprising the light emitter emitting a red color to communicate the “traffic collision” message to drivers and transmitting the received “traffic collision” message to other road markers.

17. The method of claim 11, wherein, if the received message is a “bad weather condition” message, further comprising the light emitter emitting a yellow color to communicate the “bad weather condition” message to drivers and transmitting the received “bad weather condition” message to other road markers.

18. The method of claim 11, wherein, the light colors emitted by the light emitter include at least one of green, yellow, or red.

19. The method of claim 11, further comprising:
monitoring vehicle traffic;
determining whether vehicle traffic is congested, and if so, commanding the light emitter to emit a yellow color, or, if not congested, commanding the light emitter to emit a green color; and
commanding the transmission of the monitored vehicle traffic to other road markers, to a road marker gateway and to a traffic management station.

20. A road marker to communicate emergency messages with other road markers comprising:
mean for receiving an emergency message at a road marker from an emergency vehicle, a road marker gateway, or another road marker
means for emitting a light color based upon the emergency message received; and
means for transmitting the received emergency message to at least one other road marker.

21. The road marker of claim 20, wherein, the emergency message is transmitted from an emergency vehicle to the road marker, a road marker gateway, or a traffic management station.

22. The road marker of claim 20, wherein, the emergency message is transmitted from a vehicle to a traffic management station, to a road marker gateway, and to the road marker.

23. The road marker of claim 20, wherein, the emergency message is transmitted from a traffic management station to a road marker gateway and to the road marker.

24. The road marker of claim 20, wherein, if the emergency message is a “close the lane” message, further comprising means for emitting a red color to communicate the “close the lane” message to drivers and means for transmitting the received “close the lane” message to other road markers.

25. The road marker of claim 20, wherein, if the emergency message is a “traffic collision” message, further comprising means for emitting a red color to communicate the “traffic collision” message to drivers and means for transmitting the received “traffic collision” message to other road markers.

26. The road marker of claim 20, wherein, if the received message is a “bad weather condition” message, further comprising means for emitting a yellow color to communicate the “bad weather condition” message to drivers and means for transmitting the received “bad weather condition” message to other road markers.

27. The road marker of claim 20, wherein, the light colors emitted by the light emitter include at least one of green, yellow, or red.

28. The road marker of claim 20, further comprising:
means for monitoring vehicle traffic;
means for determining whether vehicle traffic is congested, and if so, emitting a yellow color, or, if not congested, emitting a green color; and
means for commanding the transmission of the monitored vehicle traffic to other road markers, to a road marker gateway and to a traffic management station.

29. A computer program product comprising:
a computer-readable medium comprising code for:
receiving an emergency message at a road marker from an emergency vehicle, a road marker gateway, or another road marker
emitting a light color based upon the emergency message received; and
transmitting the received emergency message to at least one other road marker.

30. The computer program product of claim 29, wherein, the emergency message is transmitted from an emergency vehicle to the road marker, a road marker gateway, or a traffic management station.

31. The computer program product of claim 29, wherein, the emergency message is transmitted from a vehicle to a traffic management station, to a road marker gateway, and to the road marker.

32. The computer program product of claim 29, wherein, the emergency message is transmitted from a traffic management station to a road marker gateway and to the road marker.

33. The computer program product of claim 29, wherein, if the emergency message is a “close the lane” message, further comprising code for emitting a red color to communicate the “close the lane” message to drivers and code for transmitting the received “close the lane” message to other road markers.

34. The computer program product of claim 29, wherein, if the emergency message is a “traffic collision” message, further comprising code for emitting a red color to communicate the “traffic collision” message to drivers and code for transmitting the received “traffic collision” message to other road markers.

35. The computer program product of claim 29, wherein, if the received message is a “bad weather condition” message, further comprising code for emitting a yellow color to communicate the “bad weather condition” message to drivers and code for transmitting the received “bad weather condition” message to other road markers.

36. The computer program product of claim 29, wherein, the light colors emitted by the light emitter include at least one of green, yellow, or red.

37. The computer program product of claim 29, further comprising:
code for monitoring vehicle traffic;
code for determining whether vehicle traffic is congested, and if so, emitting a yellow color, or, if not congested, emitting a green color; and
code for commanding the transmission of the monitored vehicle traffic to other road markers, to a road marker gateway and to a traffic management station.

38. A road marker gateway to communicate emergency messages to and from road markers comprising:
a transmitter;
a receiver to receive an emergency message from a traffic management station; and
a processor to command the transmitter to transmit the emergency message to a road marker, wherein the road marker emits a light color based upon the received emergency message and transmits the received emergency message to at least one other road marker.

39. The road marker gateway of claim 38, wherein, the emergency message is transmitted from an emergency vehicle to a road marker or the road marker gateway, and the road marker gateway transmits the emergency message to the traffic management station.

40. The road marker gateway of claim 38, wherein, the emergency message is transmitted from a vehicle to the traffic management station, and the traffic management station transmits the emergency message to the road marker gateway.

41. The road marker gateway of claim 38, wherein, if the emergency message is a “close the lane” message, the road marker emits a red color to communicate the “close the lane” message to drivers and transmits the received “close the lane” message to other road markers.

42. The road marker gateway of claim 38, wherein, if the emergency message is a “traffic collision” message, the road marker emits a red color to communicate the “traffic collision” message to drivers and transmits the received “traffic collision” message to other road markers.

43. The road marker gateway of claim 38, wherein, if the emergency message is a “bad weather condition” message, the road marker emits a yellow color to communicate the “bad weather condition” message to drivers and transmits the received “bad weather condition” message to other road markers.

44. The road marker gateway of claim 38, wherein the road marker includes at least one of an optical sensor or a motion vibration sensor to monitor vehicle traffic and transmits the monitored vehicle traffic data to the road marker gateway, and the road marker gateway transmits the monitored vehicle traffic data to the traffic management station.

45. A computer program product comprising:
a computer-readable medium comprising code for:
receiving an emergency message from a traffic management station; and
transmitting the emergency message to a road marker, wherein the road marker emits a light color based upon the received emergency message and transmits the received emergency message to at least one other road marker.

46. The computer program product of claim 45, wherein, the emergency message is transmitted from an emergency vehicle to a road marker or the road marker gateway, further comprising code for transmitting the emergency message to the traffic management station.

47. The computer program product of claim 45, wherein, the emergency message is transmitted from a vehicle to a traffic management station, and the traffic management station transmits the emergency message to the road marker gateway.

48. The computer program product of claim 45, wherein, if the emergency message is a “close the lane” message, the road marker emits a red color to communicate the “close the lane” message to drivers and transmits the received “close the lane” message to other road markers.

49. The computer program product of claim 45, wherein, if the emergency message is a “traffic collision” message, the road marker emits a red color to communicate the “traffic collision” message to drivers and transmits the received “traffic collision” message to other road markers.

50. The computer program product of claim 45, wherein, if the emergency message is a “bad weather condition” message, the road marker emits a yellow color to communicate the “bad weather condition” message to drivers and transmits the received “bad weather condition” message to other road markers.

51. The computer program product of claim 45, wherein the road marker includes at least one of an optical sensor or a motion vibration sensor to monitor vehicle traffic and transmits the monitored vehicle traffic data to the road marker gateway, further comprising code for transmitting the monitored vehicle traffic data to the traffic management station.
